(19) United States
(12) Patent Application Publication
(10) Pub. No.: US 2002/0071457 A1
(43) Pub. Date: Jun. 13, 2002

(54) Pulsed non-linear resonant cavity

(76) Inventor: Josh N. Hogan, Los Altos, CA (US)

Correspondence Address: JOSH HOGAN, 620 KINGSWOOD WAY, LOS ALTOS, CA, 94022, US

(21) Appl. No.: 09/733,849

(22) Filed: Dec. 8, 2000

(51) Int. Cl. H01S 3/10

(52) U.S. Cl. 372/23

(57) ABSTRACT

This invention provides a means for generating multiple wavelengths in an integrated manner using a resonant cavity containing dispersion shifted medium and coupled to at least one pulsed laser source. The laser sources emit radiation at a particular wavelength and are pulsed in a manner synchronously related to the round trip time of the resonant cavity. The dispersion shifted medium is designed to produce a set of discrete wavelengths, by such means as four wave mixing, whose frequencies are related to the wavelength of the pulsed laser sources and the repetition frequency of the resonant cavity. The reflective elements of the resonant cavity are designed to contain the radiation of the laser sources within the resonant cavity and to transmit an equal amount of each of the generated set of wavelengths.

### BACKGROUND OF THE INVENTION

This invention relates to the area of optical sources which provide output radiation at a multiplicity of wavelengths. This has application in such areas as the optical communications industry where Dense Wavelength Division Multiplexing (DWDM) achieves high data rate transmission by independently modulating data on to a multiplicity of optical beams, each with a different wavelength. These optical beams are then combined and propagated down a single optical fiber. Since the different wavelengths do not significantly interfere with each other the multiple wavelengths are effectively independent communications channels.

Multiple wavelength sources are typically generated by having multiple laser diodes each designed to emit at one of the required wavelengths. Each laser diode may be fabricated so that it emits at a particular wavelength as in the case of Distributed Feed Back (DFB) lasers where the emitting wavelength is determined by the physical spacing of a distributed Bragg grating that is part of the laser diode. Alternately, laser diodes may be fabricated that are capable of emitting over a broad wavelength range and are tuned to a particular wavelength by means of precision temperature control or other means.

An alternative approach to generating multiple wavelengths is to generate a continuum of wavelengths by applying a high power single wavelength source for four wave mixing in a non-linear medium such as fiber. The non-linear or anharmonic characteristics allow the transformation of the source or pump radiation to other wavelengths.

High power is typically achieved be using a pulsed optical source so that high peak power can be attained with relatively low average power. The spectrum of the input optical pulse will be broadened to provide a continuum of wavelengths. The width of this continuum can be large if long lengths of conventional fiber are used. More recently “photonic crystal fiber” allows an extremely large continuum range to be generated with a relatively short length of fiber. A set of individual wavelengths can be generated from this continuum by routing the optical beam through a set of optical filters, such as distributed fiber gratings. This approach of generating a set of multiple wavelengths by filtering a continuum is inherently inefficient because the wavelengths filtered out essentially are wasted energy.

Another approach described at the SPIE Conference on Optical Fiber Communications, Taipei, Taiwan, July 1998 in a paper titled A Multi-wavelength WDM Source Generated by Four-Wave-Mixing in a Dispersion-Shifted-Fiber by Keang-Po Ho and Shien-Kuei Liaw is to combine the output of two continuous wave laser diodes that have slightly different wavelengths, amplify the combined signal with a high power Erbium Distributed Fiber Amplifier (EDFA) and apply this to a dispersion shifted fiber for four way mixing to produce a set or comb of wavelengths, whose wave length separation is determined by the difference in wavelength of the two seed laser diodes. Dispersion of a medium refers to the variation of the speed of propagation of radiation with wavelength within the medium. Typically the optical dispersion of a medium exhibits one or more minima at specific wavelengths around which the variation of speed of propagation with wavelength is small. Dispersion shifted media, such as, dispersion shifted fiber is designed to have zero dispersion close to the desired operating wavelength. (For the purpose of this application, dispersion shifted medium is also intended to include the situation where a minimum coincides with the desired operating wavelength without specific modification.) This approach, however, still requires a physically long amount of dispersion shifted medium, which requires the system to be physically large which makes it more subject to environmental changes and not compatible with a requirement of being compact. It also requires the use of an expensive EDFA.

Therefore there is an unmet need for an efficient compact method and apparatus for generating a set or comb of wavelengths in manner that is compatible with low cost fabrication and which provides an integrated source of radiation at multiple wavelengths.

### SUMMARY OF THE INVENTION

This invention provides a means for generating multiple wavelengths in an integrated manner using a resonant cavity containing dispersion shifted medium and coupled to at least one pulsed laser source. The laser sources emit radiation at a particular wavelength and are pulsed in a manner synchronously related to the round trip time of the resonant cavity. The dispersion shifted medium is designed to produce a set of discrete wavelengths whose frequencies are related to the wavelength of the pulsed laser sources and the repetition frequency of the resonant cavity. The reflective elements of the resonant cavity are designed to contain the radiation of the laser sources within the resonant cavity and to transmit an equal amount of each of the generated set of wavelengths. This invention provides an apparatus for and method of generating repetitive pulsed radiation with a multiplicity of discrete wavelengths, which includes positioning an optical processing medium in a resonant cavity with reflective elements, generating repetitive pulsed radiation from at least one laser source in at least one of a multiplicity of pump cavities with reflective elements and coupling the resonant and pump cavities.

### BRIEF DESCRIPTION OF THE DRAWINGS

FIG. 1 is an illustration of the preferred embodiment of the invention taught herein.

FIG. 2 is a detailed description of a laser source.

FIG. 3 is an illustration of a laser diode power source.

FIG. 4 is an illustration of a pulsed current source.

FIG. 5 is an illustration of an RF signal and current pulses.

FIG. 6 is an illustration of a typical reflectivity profile of an end mirror of a laser source.

FIG. 7 is an illustration of a typical reflectivity profile of an output coupler.

FIG. 8 is an illustration of a feedback system.

FIG. 9 is an illustration of a set of wavelengths, such as the ITU grid.

FIG. 10 is an illustration of a fiber based system with two pump cavities.

FIG. 11 is an illustration of a fiber based system with a single pump cavity.

### DETAILED DESCRIPTION OF THE INVENTION

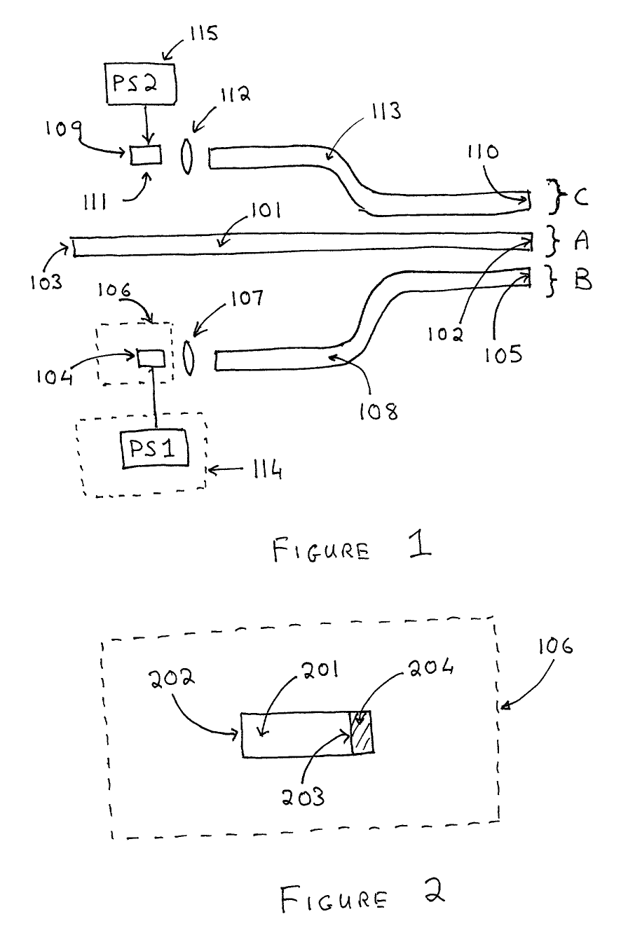

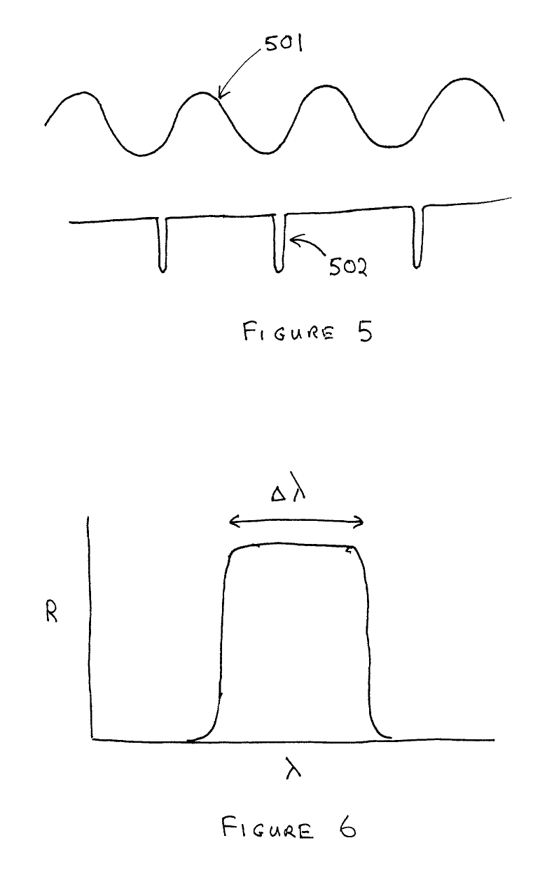

A preferred embodiment of the invention is illustrated in and described with reference to FIG. 1 where three cavities are shown. The first is a resonant cavity, labeled A, that contains the optical processing medium 101 and is bounded by the two reflective elements 102 and 103. A first pump cavity, labeled B, is also a resonant cavity bounded by the reflective elements 104 and 105. It contains a laser source 106, described in more detail with reference to FIG. 2, an optical focusing element 107 and a wave guide element 108. A second pump resonant cavity, labeled C, is bounded by the reflective elements 109 and 110 and also contains a laser source 111, a focusing element 112 and a waveguide element 113. The laser sources are driven by pulsed current sources 114 and 115, also called PS1 and PS2. The pulsed current sources are is described in more detail with reference to FIG. 5. Pulsed single wavelength radiation (referred to as pump radiation) is generated in each of the pump resonant cavities at a different wavelength. Some of this pulsed pump radiation in the pump resonant cavities is operationally coupled into the first resonant cavity, for example, through the process of waveguide coupling in the waveguide sections of the resonant cavities situated in close proximity. As this coupled pulsed radiation propagates through the optical processing medium, it generates radiation at additional wavelengths by an optical mixing process, such as of four wave mixing. (For purposes of this application wave mixing or four wave mixing will include other types of optical mixing, such as Stokes, Raman, etc.) These additional wavelengths, in turn generate further additional wavelengths all separated by the frequency difference between the initial two pump wavelengths. This process generates repetitive pulsed radiation with a multiplicity of discrete wavelengths. The optical processing medium 101 is designed to be highly non linear, which facilitates four wave mixing and it is also designed to have zero dispersion over the wavelength range being generated which allows all wavelengths to propagate through the medium at the same velocity. This process of generating additional wavelengths is enhanced by the resonant nature of the optical processing cavity, which allows multiple passes through the optical processing medium. It is also enhanced by the synchronous relationship between the repetition rate of the cavities A, B, C and the frequency separation between the pump wavelengths.

The pulsed laser sources, illustrated in FIG. 2, (wherein Band C are similar cavities and numbers in this discussion correspond to similar elements) consists of a Fabry Perot laser diode 201, with a rear flat surface 202 which forms one end mirrored surface of the resonant cavity, and has a reflective coating at the wavelength of the laser diode. The front flat surface 203 of the laser diodes is highly transmissive and has a layer of saturable absorber material 204, which is designed to shorten the temporal duration of the optical pulse. For purposes of this application these surfaces are also called facets. The optical radiation from the laser source is focused into a waveguide element 108, 113 using an optical focusing element 107,112, such as an aspheric lens or a more complex conventional system consisting of a collimating lens, an anamorphic pair and a focusing lens. The other end of the pump resonant cavities 105 and 110 are also highly reflective at the pump wavelength. The waveguide elements 108 and 113 also have distributed imprinted diffractive gratings which filter the radiation from the pump laser. The laser source is pulsed with a repetition rate that is synchronous with the round trip time of the resonant cavity. The resonant aspect of the cavity B,C induce the laser source to radiate only at the wavelength determined by the diffraction grating. Alternatively the end reflective element of the pump resonant cavities can be a reflective grating which only reflects the desired pump wavelength and thus stabilizes the wavelength of the pump laser.

Each laser source 106, 111 is pulsed because high peak power enhances the transformation of source or pump radiation into the generated multiple wavelength set by four wave mixing. Several methods of pulsing can be used, including mode locking and gain switching. In mode locking all the possible modes at which the cavity can lase are phase locked to form a short optical pulse with a repetition rate determined by the round trip time of the cavity. The preferred laser source in this embodiment is a gain switched laser diode Gain switching a laser diode may be accomplished by using a direct current to bias the laser diode close to the lasing threshold and also applying a short repetitive burst of current from an ac coupled pulsed current source. The laser diode is driven above the lasing threshold and emits a short burst of radiation. This process of maintaining the laser diode close to threshold and pulsing it above threshold is referred to as gain switching. The short current pulse may be generated, for example, by a circuit containing a step recovery diode powered by an RF signal. This approach is a method of generating a high peak power optical pulse without the use of an expensive optical amplifier. The resulting pulse of radiation may be further shortened by enhancing the saturable absorption of the laser diode. A saturable absorber is a passive technique for reducing the temporal duration of an optical pulse. The optical pulse may be further reduced by conventional techniques such as diffraction grating pairs, fiber gratings or non linear fiber loop mirrors.

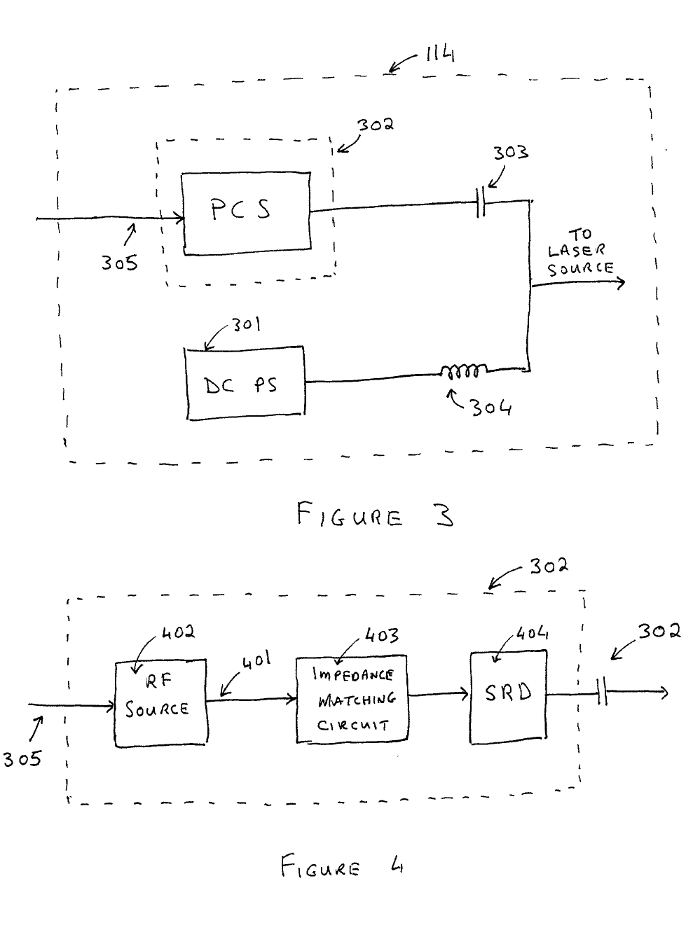

The preferred laser source is powered by an electrical power source 114, 115 that is described in more detail with reference to FIG. 3. The power source consists of two elements. The first 301, labeled DC PS, is a DC power source which biases the laser diode just below threshold. The second element 302, labeled PCS, is a pulsed current source that is AC coupled to the laser diode through a capacitive element 303. An inductive element 304 prevents the AC current flowing to the DC power source. The pulsed current source is controlled by a reference signal 305. This arrangement causes the laser diode to operate in a gain switched mode wherein the laser diode emits an optical pulse in response to the current pulse. The short current pulse can be generated by such means as illustrated in FIG. 4 where an RF signal 401, from an RF source 402 is impedance matched by matching circuitry 403 to a step recovery diode 404, labeled SRD. The step recovery diode accumulates the RF power during one phase and this energy is swept from the diode in the form of a short current pulse during the second phase of the RF cycle. FIG. 5 describes a typical relationship between the RF signal 501 and the current pulse 502 from the step recovery diode. The laser diode typically has an inherent saturable absorption effect which compresses the optical pulse in the time domain. The pulse is further compressed be the addition of a saturable absorber layer 204 in FIG. 2.

The two pump resonant cavities B and C are similar, with the exception of the wavelength at which they resonate. They each have a diffraction grating element which stabilizes each cavity at a different wavelength. The value of the wavelengths are selected to correspond to adjacent wavelengths on a standard grid, such as the ITU optical communications grid. The frequency difference between these wavelengths is the frequency separation between all of the wavelengths on the standard grid. These pump resonant cavities B and C are coupled to the resonant cavity A which contains the optically processing medium 101. This coupling transfers pulses from the two pump wavelengths to the processing resonant cavity A. The optical pulses propagate through the optical processing medium 101 of cavity A. This optical processing medium consists of highly non-linear dispersion shifted medium that is specifically designed to transform the pump radiation to a set of wavelengths separated from each other by a predetermined frequency difference. This design may include having diffractive elements in the resonant waveguide that favor at least some of the desired wavelengths. The resonant nature of the cavity then enhances the build-up of these wavelengths, which in turn enhance the build up of adjacent wavelengths separated by the same frequency separation, thereby generating the multiplicity of wavelengths.

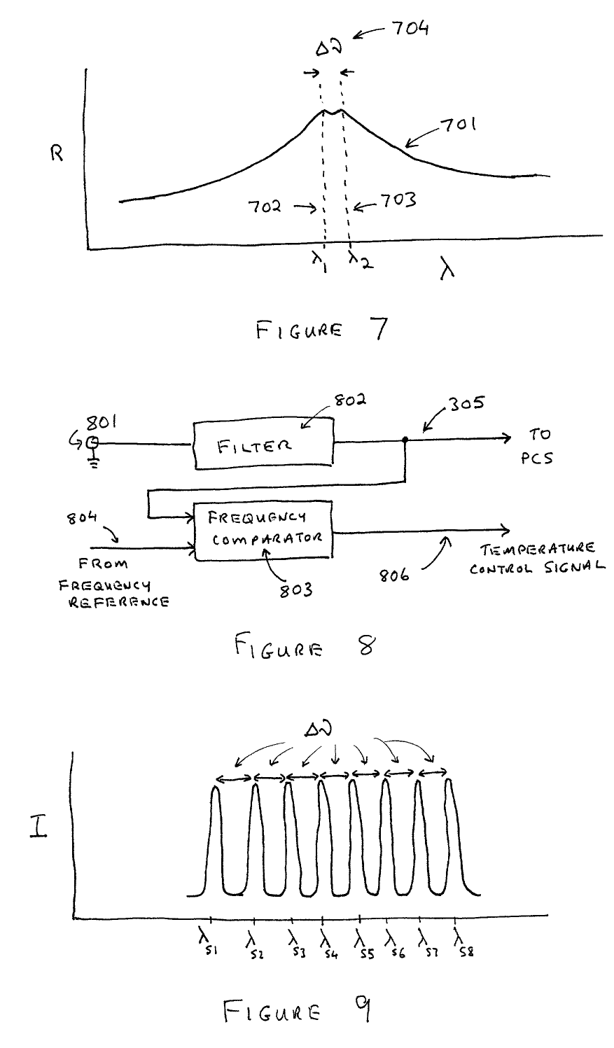

Dispersion of a medium refers to the variation of the speed of propagation of radiation with wavelength within the medium. Typically the optical dispersion of a medium exhibits one or more minima at specific wavelengths around which the variation of speed of propagation with wavelength is small. Dispersion shifted media is designed to have zero dispersion substantially over the desired operating wavelength. This allows all of the generated wavelengths to propagate at the same velocity within the resonant cavity. This optical processing resonant cavity A has one highly reflective end element 102, that has a reflective profile illustrated in FIG. 6 and a second reflective end element 103, acting as the output coupler with a reflective profile similar to that illustrated in FIG. 7. In FIG. 6 the reflectivity is high for wavelengths within the desired wavelength range 601, called Δλ. In FIG. 7 the reflectivity is high at the pump wavelengths 702 labeled λ1 and 703 labeled Δ2 which are different by the frequency separation 704 labeled Δν. This arrangement causes the pump wavelengths and the generated set of wavelengths to remain substantially within the resonant cavity A, while wavelengths outside the desired range are discarded through the reflective element 102. The output coupler 103 emits the set of generated wavelengths with output powers equalized by the varying reflectivity profile 701.

The non linear characteristics of the dispersion shifted medium cause an interaction between the short optical pulse and the medium which transforms the pump radiation to a continuum of wavelengths. This non linear aspect is enhanced in medium referred to as photonic fiber or photonic crystal or photonic crystal fiber. By locating the dispersion shifted medium within a resonant cavity, into which the pump pulses are coupled, the optical pump pulses circulate within the cavity and effectively extend the interaction length of the optical pulse and the non-linear dispersion shifted medium. The resonant cavity can also be designed such that the optical length of the cavity (and hence its round trip time) corresponds to a frequency which is harmonically related to the frequency separation of the desired wavelength set. The optical pump diode is also pulsed with a repetition rate that is synchronous with the round trip time of the cavities.

The length of the resonant cavity is actively controlled by a feedback system illustrated in FIG. 8. The optical pulse sequence is detected by a detector 801 and its output signal is filtered by a filter 802, such as a phase lock loop. The output of this filter is the signal 305, which is used as the reference signal of the pulsed current source PCS. The signal 305 is also applied to a frequency comparison system 803, where it is compared with a frequency reference signal to produce an error signal 806 that is used to control the optical length by such means as of temperature control. In this manner, the resonant cavity length and the repetition rate of the current pulses are stabilized to the same frequency reference. Using distributed reflective gratings as the reflective elements of the pump cavities allows the pump cavities to lock to the current pulses automatically.

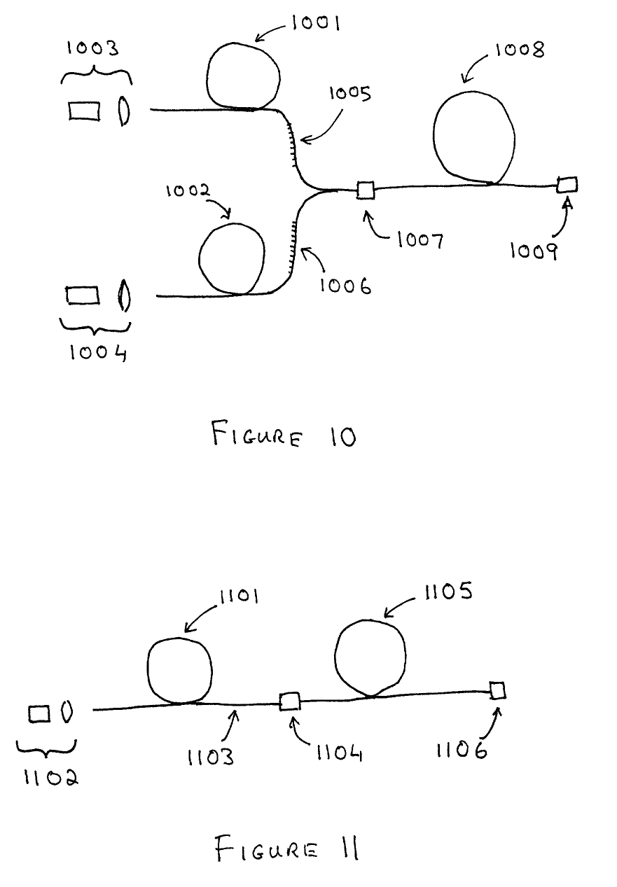

The combination of stabilizing the pump wavelengths to specific wavelengths separated by the desired frequency separation (related to the frequency reference), synchronizing the repetition rate of the current pulse with the round trip time of the resonant cavity, locking to the frequency reference and designing the dispersion shifted medium to favor propagation of specific wavelengths, enhances generation of the complete set of desired wavelengths. The frequency reference is chosen to be related to the desired frequency separation of the wavelength set. In this manner, the frequency separation of the wavelength set is contrived to be the frequency separation of a standard grid such as an ITU optical communications grid. The absolute values of the generated set of wavelengths are determined by the values of the stabilized pump wavelengths. An ideal set of generated wavelengths is illustrated in FIG. 9, where 8 wavelengths λ_{S1} to λ_{S8} all have substantially the same intensity, I, and all are separated by the same frequency difference Δν which is harmonically related to the frequency reference. Typically, λ_{S4} and λ_{S5} would correspond to λ₁ and λ₂ of FIG. 7. The transmission characteristics of the two end mirrors (or reflective elements) of the resonant cavity are designed to equalize the output powers of the set of generated wavelengths.

Alternative preferred embodiments are illustrated in FIGS. 10 and 11.

In FIG. 10, two pump fiber based resonant cavities 1001 and 1002, which include the pulsed laser sources and focusing elements 1003 and 1004, (similar to the sources and focusing elements 106, 111 and 107, 112 respectively, which are discussed in the preferred embodiment) and the reflective gratings 1005 and 1006. These gratings feed back a portion of the radiation emitted by the laser source in a resonant manner to stabilize each laser at a particular desired wavelength. The distributed nature of the reflective gratings allow the cavity to automatically lock to the applied repetitive current pulse. The output of these two cavities are combined and the combination is coupled by a coupler 1007 into a resonant cavity 1008, containing the optical processing medium. This cavity contains the highly non-linear dispersion shifted fiber which transforms the two pump wavelengths into the desired set of wavelengths. This cavity may also have distributed gratings designed to enhance the selection of at least some of the desired wavelengths. The output coupler 1009 of this cavity is a reflective element, either grating or coating that has a profile similar to that illustrated in FIG. 7. Other aspects of this embodiment, such as a feedback system to stabilize the system to a frequency reference, are similar to aspects described in the preferred embodiment.

In FIG. 11, a single fiber based pump cavity 1101, which includes a pulsed laser source and focusing element 1102 (as described in the preferred embodiment) and a reflective gratings 1103, to stabilize the wavelength of the laser source. The output of this cavity is coupled by a coupler 1104 into a second fiber based resonant cavity 1105. This cavity contains the highly non-linear dispersion shifted fiber which transforms the pump wavelength into the desired set of wavelengths by means of distributed gratings which enhance the selection of at least some of the desired wavelengths. The mechanism for this selection is to preferentially reflect in a resonant manner these selected wavelengths. These wavelengths will initially exist because of noise level mixing and by being preferentially reflected will enhance the generation of these wavelengths.

This process of seeding of the four wave mixing process will build up these wavelengths, which in turn will build up the adjacent wavelengths of the desired wavelength set. In this manner the desired wavelength set will be generated from a single pump laser source. The output coupler 1106 of this cavity is a reflective element, either grating or coating that has a profile similar to that illustrated in FIG. 7. Other aspects of this embodiment, such as a feedback system to stabilize the system to a frequency reference, are similar to aspects described in the preferred embodiment.

It is understood that the above description is intended to be illustrative and not restrictive. Many of the features have functional equivalents that are intended to be included in the invention as being taught. For example, the saturable absorber element could be fully integrated with the laser diode, or other pulse compression techniques, such as non-linear fiber loop or diffraction grating pairs could be used to reduce the duration of the pulse. The laser diode could, for example, be a distributed feedback laser. At least one of the mirrored elements of the resonant cavity could be etched facets, distributed feedback reflectors or distributed Bragg reflectors with deep etched grooves. Various combinations of waveguide elements and fiber based elements can be employed. Other examples will be apparent to persons skilled in the art.

The scope of this invention should therefore not be determined with reference to the above description, but instead should be determined with reference to the appended claims, along with the full scope of equivalents to which such claims are entitled.

What is claimed is:

1. A method of generating repetitive pulsed radiation with a multiplicity of discrete wavelengths,
the method comprising:
positioning an optical processing medium in a resonant cavity with reflective elements; and
generating repetitive pulsed radiation from at least one laser source in at least one of a multiplicity of pump cavities with reflective elements; and
coupling the resonant and pump cavities, such that repetitive pulsed radiation with a multiplicity of wavelengths is generated.

2. The method of claim 1, wherein the resonant cavity is coupled to a pair of pump cavities, each with a pulsed laser source radiating at a single wavelength.

3. The method of claim 2, wherein the wavelengths at which the pump cavities radiate differ by an amount related to the frequency separation of the desired wavelength set.

4. The method of claim 2, wherein the wavelength values of the pump cavities correspond to the wavelengths on a standard grid.

5. The method of claim 4, wherein the standard grid is an optical communications ITU grid.

6. The method of claim 1, wherein the repetition rate of the pulsed laser source is harmonically related to the desired frequency separation of the generated set of wavelengths.

7. The method of claim 1, wherein the pump cavities are resonant cavities with round trip times harmonically related to the repetition rate of the optical pulses from the laser sources.

8. The method of claim 1, wherein the signal determining the repetition rate of the pulsed laser source is derived from the optical pulse output from at least one of the cavities.

9. The method of claim 1, wherein the repetition rate of the laser source is maintained at fixed value by means of feedback circuitry, a control mechanism and a stable reference.

10. The method of claim 9, wherein the control mechanism is temperature control.

11. The method of claim 1, wherein the optical processing medium is dispersion shifted medium.

12. The method of claim 1, wherein the optical processing medium is dispersion shifted fiber.

13. The method of claim 1, wherein the optical processing medium is photonic crystal fiber.

14. The method of claim 1, wherein the optical processing medium is photonic crystal.

15. The method of claim 1, wherein the optical processing medium is capable of producing a multiplicity of wavelengths separated by a frequency difference.

16. The method of claim 1, wherein the optical processing medium has zero dispersion centered on the desired multiplicity of wavelengths.

17. The method of claim 1, wherein the optical processing medium is highly non-linear medium.

18. The method of claim 15, wherein the fixed value of the frequency separation between the wavelengths of the generated wavelength set corresponds to a frequency separation on a standard grid.

19. The method of claims 18 wherein the standard grid is an optical communications ITU grid.

20. The method of claim 1, wherein the laser source is a pulsed laser diode.

21. The method of claim 1, wherein the laser source is a gain switched laser diode.

22. The method of claim 21, wherein the gain switched laser diode receives a current pulse from circuitry containing a step recovery diode and an RF source.

23. The method of claim 1, wherein the laser source is a mode locked laser source

24. The method of claim 1, wherein the peak power of the pulsed output of the pulsed laser source is increased by compressing the temporal duration of the pulses.

25. The method of claim 24, wherein the temporal compression of the pulsed radiation is achieved by means of saturable absorption.

26. The method of claim 24, wherein the temporal compression of the pulsed radiation is achieved by means of diffraction gratings.

27. The method of claim 24, wherein the temporal compression of the pulsed radiation is achieved by means of distributed fiber diffraction grating.

28. The method of claim 24, wherein the temporal compression of the pulsed radiation is achieved by means of at least one non linear fiber loop.

29. The method of claim 1, wherein the resonant cavity and the pump cavities are co-located as a single resonant cavity, said single resonant cavity being comprised of the laser sources, the optical processing medium and reflective elements.

30. The method of claim 1, wherein at least one reflective element is a facet of a laser source.

31. The method of claim 1, wherein at least one reflective element is an end of the optical processing medium.

32. The method of claim 1, wherein the reflective elements are distributed Bragg gratings.

33. The method of claim 1, wherein one reflective element is coated so that it is highly reflective at the wavelengths of the generated set and at the wavelength of the laser source.

34. The method of claim 1, wherein at least some of the reflective elements transmits an equal amount of intensity of each wavelength in the generated set of wavelengths.

35. The method of claim 1, wherein the pump cavities are coupled to the resonant cavity by means of fiber coupling.

36. The method of claim 2, wherein the pair of pump cavities are stabilized at fixed wavelength values by means of distributed Bragg gratings.

37. The method of claim 2, wherein the pair of pump cavities are stabilized at fixed wavelength values by means of seeding by low power wavelength stabilized laser diodes.

38. The method of claim 1, wherein the cavities include waveguide elements.

39. The method of claim l, wherein at least the resonant cavity is a waveguide resonant cavity.

40. The method of claim 1, wherein the cavities are coupled by means of coupled waveguide elements.

41. The method of claim 1, wherein the first resonant cavity has a fiber coupled output.

42. The method of claim 1, wherein the resonant cavity is coupled to a single pump cavity with a single pulsed laser source radiating at a single wavelength.

43. The method of claim 42, wherein the single pulsed laser source emits at a repetition rate harmonically related to the frequency separation of the set of wavelengths to be generated.

44. The method of claim 42, wherein the resonant cavity has a round trip time harmonically related to the frequency separation of the set of wavelengths to be generated.

45. The method of claim 42, wherein two additional low power continuous wave lasers are coupled into the resonant cavity to seed generation of additional wavelengths.

46. The method of claim 45, wherein the wavelength values of the continuous wave lasers are the same as the values of adjacent wavelengths of the set of wavelengths to be generated.

47. The method of claim 42, wherein the resonant cavity contains reflective elements that reflect radiation at least at some of the wavelengths of the set of wavelengths to be generated.

48. The method of claim 47, wherein the reflected radiation seeds further generation of these first generated wavelengths.

49. The method of claim 48, wherein resonant reflections of the generated first wavelengths seed generation additional wavelengths.

50. An apparatus for generating repetitive pulsed radiation with a multiplicity of discrete wavelengths, the apparatus consisting of:
an optical processing element with reflective elements, said optical processing element operable in a multiple pass resonant manner; and
at least one optically active element with reflective elements, said optically active element operable to generate pulsed optical pump radiation and optically coupled to the optical processing element; and
operable to transmit such pulsed optical pump radiation to the optical processing element; and
operable to generate pulsed radiation with a multiplicity of discreet wavelengths.

51. The apparatus of claim 50, wherein the optically active element is a pump cavity operable to radiate at a specific wavelength

52. The apparatus of claim 51, wherein two optically active elements are coupled to the optical processing element.

53. The apparatus of claim 52, wherein the two optically active elements radiate at wavelengths that differ from each other by an amount related to the frequency separation of the desired discrete wavelength set.

54. The apparatus of claim 53, wherein the wavelength values of the optically active elements correspond to the wavelengths on a standard grid.

55. The apparatus of claim 50, wherein the repetition rate of the pulsed optical pump radiation is harmonically related to the desired frequency separation of the generated set of wavelengths.

56. The apparatus of claim 50, wherein the signal determining the repetition rate of the pulsed optical radiation is derived from the pulsed radiation.

57. The apparatus of claim 50, wherein the repetition rate of the pulsed optical radiation is maintained at fixed value by means of feedback circuitry, a control mechanism and a stable reference.

58. The apparatus of claim 57, wherein the control mechanism is temperature control.

59. The apparatus of claim 50, wherein the optical processing element includes dispersion shifted medium.

60. The apparatus of claim 50, wherein the optical processing element includes dispersion shifted fiber.

61. The apparatus of claim 50, wherein the optical processing element includes photonic crystal fiber.

62. The apparatus of claim 50, wherein the optical processing element includes photonic crystal.

63. The apparatus of claim 50, wherein the optical processing element has zero dispersion centered on the desired multiplicity of wavelengths.

64. The apparatus of claim 50, wherein the optical processing element includes highly non-linear medium.

65. The apparatus of claim 50, wherein the optically active element includes a pulsed laser diode.

66. The apparatus of claim 50, wherein the optical processing medium has reflective elements at both ends enabling said optical processing medium to operate in a multiple pass resonant manner.

67. The apparatus of claim 50, wherein the optically active element includes a gain switched laser diode.

68. The apparatus of claim 67, wherein the gain switched laser diode receives a current pulse from circuitry containing a step recovery diode and an RF source.

69. The apparatus of claim 50, wherein the optically active element includes a mode locked laser source

70. The apparatus of claim 50, wherein the peak power of the pulsed optical pump radiation output of the optically active element is increased by compressing the temporal duration of the pulses.

71. The apparatus of claim 70, wherein the temporal compression of the pulsed optical pump radiation is achieved by means of saturable absorption.

72. The apparatus of claim 70, wherein the temporal compression of the pulsed optical pump radiation is achieved by means of diffraction gratings.

73. The apparatus of claim 70, wherein the temporal compression of the pulsed optical pump radiation is achieved by means of distributed fiber diffraction grating.

74. The apparatus of claim 70, wherein the temporal compression of the pulsed optical pump radiation is achieved by means of at least one non linear fiber loop.

75. The apparatus of claim 50, wherein the optical processing element and the optically active elements are coupled by means of both being positioned between reflective elements operable to confine predetermined amounts of the repetitive pulsed pump radiation and the repetitive generated pulsed radiation.

76. The apparatus of claim 50, wherein at least one reflective element is a facet of a laser source.

77. The apparatus of claim 50, wherein at least one reflective element is an end of the optical processing element.

78. The apparatus of claim 50, wherein the reflective elements are distributed Bragg gratings.

79. The apparatus of claim 50, wherein one reflective element is coated so that it is highly reflective at the wavelengths of the generated set of wavelengths and at the wavelength of the pulsed optical pump radiation.

80. The apparatus of claim 50, wherein at least one of the reflective elements transmits an equal amount of power of each wavelength in the generated set of wavelengths.

81. The apparatus of claim 50, wherein the optically active elements are coupled to the optical processing element by means of fiber coupling.

82. The apparatus of claim 53, wherein the two optically active elements are stabilized at fixed wavelength values by means of distributed Bragg gratings.

83. The apparatus of claim 53, wherein the two optically active elements are stabilized at fixed wavelength values by means of seeding by low power wavelength stabilized laser diodes.

84. The apparatus of claim 50, wherein the generated multiplicity of wavelengths are coupled to an optical fiber.

85. The apparatus of claim 50, wherein a single optically active element is optically coupled to the optical processing element.

86. The apparatus of claim 85, wherein the single optically active element emits pulsed optical pump radiation at a repetition rate harmonically related to the frequency separation of the set of wavelengths to be generated.

87. The apparatus of claim 85, wherein two additional low power continuous wave lasers are operable to couple additional radiation at two different wavelengths to the optical processing element.

88. The apparatus of claim 87, wherein the additional radiation at two different wavelengths are operable to seed generation of additional wavelengths.

89. The apparatus of claim 87, wherein the two wavelength values of the additional wavelengths are the same as the values of adjacent wavelengths of the set of wavelengths to be generated.

90. The apparatus of claim 85, wherein the optical processing element contains reflective elements that reflect radiation at least at some of the wavelengths of the set of wavelengths to be generated.

91. The apparatus of claim 90, wherein the reflected radiation is operable to seed further generation of these first generated wavelengths.

92. The apparatus of claim 91, wherein reflections of the generated first wavelengths are operable to seed generation of additional wavelengths.

93. A pulse generation means operable to generate repetitive pulsed radiation with a multiplicity of discrete wavelengths, the means comprising:
means for positioning an optical processing medium in a resonant cavity with reflective elements; and
means for generating repetitive pulsed radiation from at least one laser source in at least one of a multiplicity of pump cavities with reflective elements; and
means of coupling the resonant and pump cavities, such that repetitive pulsed radiation with a multiplicity of wavelengths is generated.
